(19) United States
(12) Patent Application Publication
(10) Pub. No.: US 2025/0337651 A1
(43) Pub. Date: Oct. 30, 2025

(54) NETWORK QUALITY OF SERVICE MEASUREMENT METHOD, RELATED DEVICE, AND STORAGE MEDIUM

(71) Applicant: Tencent Technology (Shenzhen) Company Limited, Shenzhen (CN)

(72) Inventor: Zhuoyun ZHANG, Shenzhen (CN)

(21) Appl. No.: 19/263,353

(22) Filed: Jul. 8, 2025

Related U.S. Application Data
(63) Continuation of application No. PCT/CN2024/085406, filed on Apr. 2, 2024.

(30) Foreign Application Priority Data
May 6, 2023 (CN) 202310508702.X

(51) Int. Cl. H04L 41/0894; H04W 24/10; H04W 28/02

(52) U.S. Cl. CPC H04L 41/0894; H04W 24/10; H04W 28/0268

(57) ABSTRACT

Embodiments of the present disclosure provide a network quality of service (QOS) measurement method performed by multiple related computer devices acting as a policy control function (PCF), a session management function (SMF), and a user plane function (UPF) of a wireless network. The PCF generates respective policy and charging control (PCC) rules of n data flows and transmits the respective PCC rules of the n data flows to the SMF. The SMF generates respective QoS detection requests of the n data flows according to the respective PCC rules of the n data flows and transmits the respective QoS detection requests of the n data flows to the UPF, which then performs associated measurement on the QoS parameters to be measured of the n data flows accordingly.

### CROSS-REFERENCE TO RELATED APPLICATIONS

This application is a continuation application of PCT Patent Application No. PCT/CN2024/085406, entitled “NETWORK QUALITY OF SERVICE MEASUREMENT METHOD AND RELATED DEVICE” filed on Apr. 2, 2024, which claims priority to Chinese Patent Application No. 202310508702.X, filed with the China National Intellectual Property Administration on May 6, 2023 and entitled “NETWORK QUALITY OF SERVICE MEASUREMENT METHOD AND RELATED DEVICE”, both of which are incorporated herein by reference in their entirety.

### FIELD OF THE TECHNOLOGY

The present disclosure relates to the field of communication technologies, and specifically, to a network quality of service (QOS) measurement method, a communication device, a computer-readable storage medium, and a computer program product.

### BACKGROUND OF THE DISCLOSURE

QoS is used for defining a capability of a network to provide different levels of service guarantee for various forms of traffic, and is a technology for optimizing network use by determining a traffic priority according to a service target.

For a particular service, a mobile network may divide data packets of different types or characteristics of the service into a plurality of QOS flows for transmission.

### SUMMARY

An embodiment of the present disclosure provides a network QoS measurement method, performed by a computer device acting as a policy control function (PCF) of a wireless network and the method including: generating respective policy and charging control (PCC) rules of n data flows, n being a positive integer, each of the PCC rules including a QoS detection rule, each of the QoS detection rules including an association identifier and a QoS parameter to be measured, the n data flows having the same association identifier and same QoS parameters to be measured, and the association identifier being configured for instructing to perform associated measurement on the QoS parameters to be measured of the n data flows; and transmitting the respective PCC rules of the n data flows to a session management function (SMF).

An embodiment of the present disclosure provides a network QoS measurement method performed by a computer device acting as an SMF of the wireless network and the method including: receiving respective PCC rules of n data flows, n being a positive integer, each of the PCC rules including a QoS detection rule, each of the QoS detection rules including an association identifier and a QoS parameter to be measured, the n data flows having the same association identifier and same QoS parameters to be measured, and the association identifier being configured for instructing to perform associated measurement on the QoS parameters to be measured of the n data flows; generating respective QoS detection requests of the n data flows according to the respective PCC rules of the n data flows, each of the QoS detection requests including associated measurement indication information and the QoS parameter to be measured, and the n data flows having same associated measurement indication information; and transmitting the respective QoS detection requests of the n data flows to a user plane function (UPF) to instruct, by using the associated measurement indication information, the UPF to perform associated measurement on the QoS parameters to be measured of the n data flows.

An embodiment of the present disclosure provides a network QoS measurement method performed by a computer device acting as a UPF and the method including: receiving respective QoS detection requests of n data flows, each of the QoS detection requests including associated measurement indication information and a QoS parameter to be measured, the n data flows having the same associated measurement indication information and same QoS parameters to be measured, and the associated measurement indication information being configured for instructing the UPF to perform associated measurement on the QoS parameters to be measured of the n data flows; and performing associated measurement on the QoS parameters to be measured of the n data flows according to the respective QoS detection requests of the n data flows to obtain associated measurement information.

An embodiment of the present disclosure provides a PCF, including: a processing unit, configured to generate respective PCC rules of n data flows, n being a positive integer, each of the PCC rules including a QoS detection rule, each of the QoS detection rules including an association identifier and a QoS parameter to be measured, the n data flows having the same association identifier and same QoS parameters to be measured, and the association identifier being configured for instructing to perform associated measurement on the QoS parameters to be measured of the n data flows; and a transmission unit, configured to transmit the respective PCC rules of the n data flows to an SMF.

An embodiment of the present disclosure provides an SMF, including: a receiving unit, configured to receive respective PCC rules of n data flows, n being a positive integer, each of the PCC rules including a QoS detection rule, each of the QoS detection rules including an association identifier and a QoS parameter to be measured, the n data flows having the same association identifier and same QoS parameters to be measured, and the association identifier being configured for instructing to perform associated measurement on the QoS parameters to be measured of the n data flows; a processing unit, configured to generate respective QoS detection requests of the n data flows according to the respective PCC rules of the n data flows, each of the QoS detection requests including associated measurement indication information and the QoS parameter to be measured, and the n data flows having same associated measurement indication information; and a transmission unit, configured to transmit the QoS detection requests to a UPF to instruct, by using the associated measurement indication information, the UPF to perform associated measurement on the QoS parameters to be measured of the n data flows.

An embodiment of the present disclosure provides a UPF, including: a receiving unit, configured to receive respective QoS detection requests of n data flows, each of the QoS detection requests including associated measurement indication information and a QoS parameter to be measured, the n data flows having the same associated measurement indication information and same QoS parameters to be measured, and the associated measurement indication information being configured for instructing the UPF to perform associated measurement on the QoS parameters to be measured of the n data flows; and a processing unit, configured to perform associated measurement on the QoS parameters to be measured of the n data flows according to the respective QoS detection requests of the n data flows to obtain associated measurement information.

An embodiment of the present disclosure provides a communication device, including: one or more processors; and a memory, configured to store one or more programs, the one or more programs, when executed by the one or more processors, causing the communication device to implement the network QoS measurement method in the embodiments of the present disclosure.

An embodiment of the present disclosure provides a computer-readable storage medium, having a computer program stored therein, the computer program, when run on a computer, causing the computer to implement the network QoS measurement method in the embodiments of the present disclosure.

An embodiment of the present disclosure provides a computer program product, including a computer program, the computer program, when executed by a computer, implementing the network QoS measurement method in the embodiments of the present disclosure.

### BRIEF DESCRIPTION OF THE DRAWINGS

FIG. 1 is a schematic diagram of an architecture of a communication system according to an embodiment of the present disclosure.

FIG. 2 is a diagram of a system architecture of a 5G network according to an embodiment of the present disclosure.

FIG. 3 is a schematic flowchart of a network QoS measurement method according to an embodiment of the present disclosure.

FIG. 4 is a schematic flowchart of a network QoS measurement method according to another embodiment of the present disclosure.

FIG. 5 is a schematic flowchart of a network QoS measurement method according to still another embodiment of the present disclosure.

FIG. 6 is a schematic interaction diagram of a network QoS measurement method according to an embodiment of the present disclosure.

FIG. 7 is a schematic interaction diagram of a network QoS measurement method according to another embodiment of the present disclosure.

FIG. 8 is a schematic block diagram of a PCF according to an embodiment of the present disclosure.

FIG. 9 is a schematic block diagram of an SMF according to another embodiment of the present disclosure.

FIG. 10 is a schematic block diagram of a UPF according to another embodiment of the present disclosure.

FIG. 11 is a schematic structural diagram of a communication device according to an embodiment of the present disclosure.

### DESCRIPTION OF EMBODIMENTS

To make objectives, technical solutions, and advantages of the present disclosure more apparent, the following describes in detail exemplary embodiments of the present disclosure with reference to the accompanying drawings. In the accompanying drawings, the same reference numeral always represents the same component. The embodiments described herein are illustrative only and are not to be construed as a limitation on the scope of the present disclosure.

The technical solutions of the embodiments of the present disclosure may be applied to various communication systems, for example: a global system for mobile communications (GSM) system, a code division multiple access (CDMA) system, a wideband code division multiple access (WCDMA) system, a general packet radio service (GPRS) system, a long term evolution (LTE) system, an LTE frequency division duplex (FDD) system, an LTE time division duplex (TDD) system, a universal mobile communications system (UMTS), a worldwide interoperability for microwave access (WiMAX) communication system, a 5G system, or a future evolved mobile communication system.

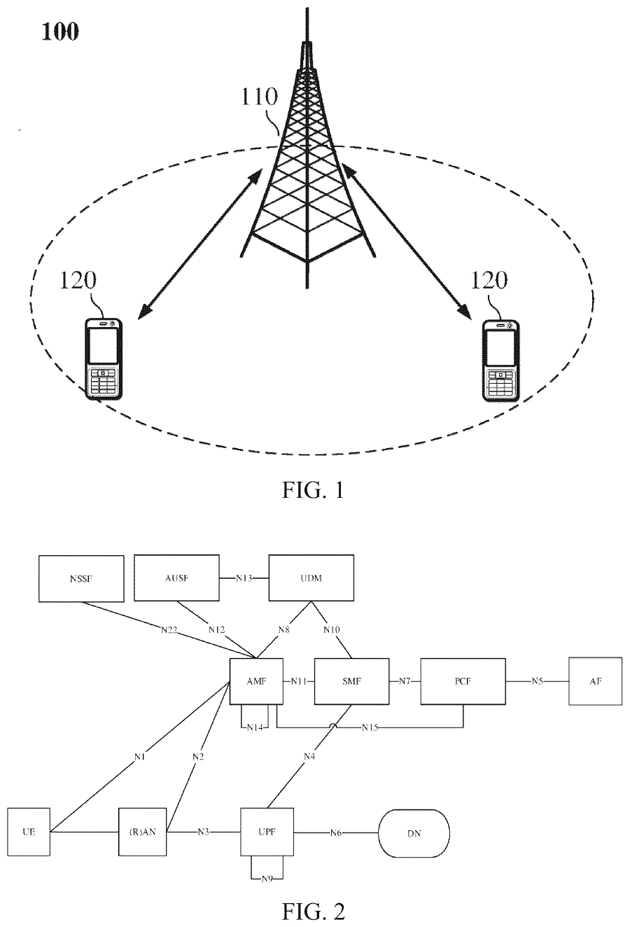

For example, a communication system 100 to which an embodiment of the present disclosure is applied is shown in FIG. 1. The communication system 100 may include a network device 110, and the network device 110 may be a device communicating with a terminal 120 (or referred to as a communication terminal or a terminal). The network device 110 may provide communication coverage for a specific geographic area and may communicate with a terminal located within the coverage area. In some embodiments, the network device 110 may be a base transceiver station (BTS) in the GSM system or the CDMA system, a NodeB (NB) in the WCDMA system, an evolved NodeB (eNB or eNodeB) in the LTE system, a base station in a 5G communication system, or a wireless controller in a cloud radio access network (CRAN). Alternatively, the network device may be a mobile switching center, a relay station, an access point, an in-vehicle device, a wearable device, a hub, a switch, a bridge, a router, a network-side device in a 5G network, a network device in a future evolved public land mobile network (PLMN), or the like.

The communication system 100 further includes at least one terminal 120 located within the coverage area of the network device 110. As used herein, the “terminal” includes, but is not limited to, a connection via a wired line, such as via a public switched telephone network (PSTN), a digital subscriber line (DSL), a digital cable, or a direct cable connection; and/or another data connection/network; and/or via a wireless interface such as for a cellular network, a wireless local area network (WLAN), a digital television network such as a DVB-H network, a satellite network, or an AM-FM broadcast transmitter; and/or an apparatus configured to receive/transmit a communication signal in another terminal; and/or an Internet of things (IoT) device. A terminal configured to communicate via a wireless interface may be referred to as a “wireless communication terminal”, a “wireless terminal”, or a “mobile terminal”. An example of the mobile terminal includes, but is not limited to, a satellite or a cellular phone; a personal communications system (PCS) terminal that may combine a cellular radio telephone with data processing, facsimile, and data communication capabilities; a personal digital assistant (PDA) that may include a radio telephone, a pager, Internet/Intranet access, a Web browser, a notebook, a calendar, and/or a global positioning system (GPS) receiver; and a conventional laptop and/or palmtop receiver or other electronic devices including a radio telephone transceiver. The terminal may refer to an access terminal, a user equipment (UE), a subscriber unit, a subscriber station, a mobile station, a mobile console, a remote station, a remote terminal, a mobile device, a user terminal, a terminal, a wireless communication device, a user agent, or a user apparatus. The access terminal may be a cellular phone, a cordless phone, a session initiation protocol (SIP) phone, a wireless local loop (WLL) station, a PDA, a handheld device having a wireless communication function, a computing device or another processing device connected to a wireless modem, an in-vehicle device, a wearable device, a terminal in the 5G network, a terminal in the future evolved PLMN, or the like.

In some embodiments, device to device (D2D) communication may be performed between terminals 120.

FIG. 1 exemplarily shows one network device and two terminals. In some embodiments, the communication system 100 may include a plurality of network devices, and in a coverage area of each network device, another number of terminals may be included. This is not limited in the embodiments of the present disclosure.

In some embodiments, the communications system 100 may further include other network elements such as a PCF, an access and mobility management function (AMF), an SMF, and a UPF. This is not limited in the embodiments of the present disclosure.

In the embodiments of the present disclosure, a device having a communication function in a network/system may be referred to as a communication device. Using the communication system 100 shown in FIG. 1 as an example, the communication device may include the network device 110 and the terminal 120 that have the communication function. The network device 110 and the terminal 120 may be the specific devices described above. Details are not described herein again.

The terms “system” and “network” in this specification are usually used interchangeably in this specification. The term “and/or” in this specification describes only an association relationship between associated objects and represents that three relationships may exist. For example, A and/or B may represent the following three cases: only A exists, both A and B exist, and only B exists.

FIG. 2 is a diagram of a system architecture of a 5G network according to an embodiment of the present disclosure. As shown in FIG. 2, devices included in a 5G network system include a terminal (UE), a radio access network (RAN), a UPF, a data network (DN), an AMF, an SMF, a PCF, an application function (AF), an authentication server function (AUSF), and a unified data management function (UDM).

In some embodiments, when QoS measurement needs to be performed on a service, a solution is usually to perform independent measurement on a single QoS flow of the service. However, for a service having a plurality of QoS flows, if such a solution is used and each QoS flow is separately measured independently, a QoS parameter measurement result of the service may have a relatively large error.

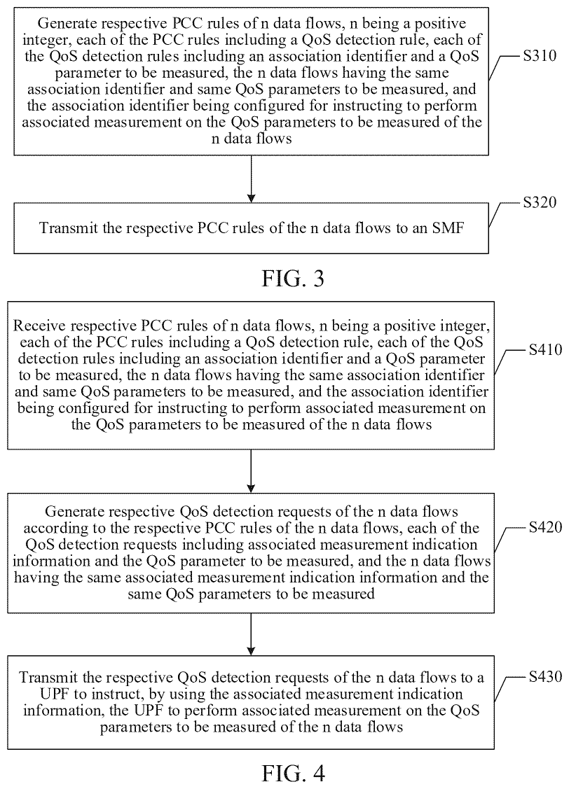

FIG. 3 is a schematic flowchart of a network QoS measurement method according to an embodiment of the present disclosure. The method provided in the embodiment of FIG. 3 may be performed by a PCF, but the present disclosure is not limited thereto. As shown in FIG. 3, the method provided in this embodiment of the present disclosure may include the following operations.

S310: Generate respective PCC rules of n data flows, n being a positive integer greater than or equal to 1. Each of the PCC rules may include a QoS detection rule, each of the QoS detection rules may include an association identifier and a QoS parameter to be measured, and the n data flows have the same association identifier and same QoS parameters to be measured. The association identifier may be configured for instructing to perform associated measurement on the QoS parameters to be measured of the n data flows.

In this embodiment of the present disclosure, for a PCF side, the n data flows are n service data flows; while for an SMF side and a UPF side, the n data flows are n QoS flows. There is a one-to-one mapping relationship between the n service data flows and the n QoS flows.

In some embodiments, the n data flows may come from a single UE or a plurality of UEs.

In this embodiment of the present disclosure, for a particular target service or some particular target services, a mobile network may divide data packets of different types or characteristics of the target service into a plurality of (two or more) service data flows for transmission. The PCF may generate respective PCC rules of n service data flows of the target service, and transmit the generated n PCC rules to the SMF. After receiving the n PCC rules, the SMF may bind the n PCC rules to n QoS flows, respectively. The data packet of the target service is a data packet (which may include an uplink data packet and/or a downlink data packet) transmitted by a terminal (which is represented by a UE below) and/or a service server. The target service may be set according to an actual requirement, for example, may be a particular service that requires a high data rate and a short delay, such as augmented reality (AR) or virtual reality (VR). For another example, the target service may be a multimedia service, and data packets of different types, such as audio, videos, and text, in the multimedia service may be divided into a plurality of service data flows for transmission.

When QoS measurement needs to be performed for the target service, because the target service is divided into a plurality of service data flows inside a network (for example, a 5G network), the PCF may generate a plurality of PCC rules of the target service, and QoS detection rules of the plurality of PCC rules all include a same association identifier. In this way, the PCF may instruct, by using the same association identifier, to perform associated measurement on the plurality of QoS flows of the target service. Associated measurement means that after receiving the plurality of PCC rules of the target service, the SMF binds the PCC rules to the corresponding QoS flows (the binding of the PCC rules to the QoS flows follows provisions in an existing standard), and instructs, according to the same association identifier included in the plurality of PCC rules, the UPF to perform associated measurement on QoS parameters to be measured of the plurality of QoS flows, rather than perform independent measurement on the QoS parameters to be measured of the QoS flows, respectively. The associated measurement may obtain a plurality of measurement results of the QoS parameters to be measured of the plurality of QoS flows at a same or approximately same moment, and may further be configured for obtaining a total measurement result (referred to as an associated calculation result below) of the QoS parameters to be measured of the target service at the same or approximately same moment. Because the plurality of measurement results are obtained by simultaneously measuring the plurality of QoS flows at a same or approximately same time point, using these measurement values to further calculate the total measurement result of the QoS parameters of the target service, for example, an average value of the measurement values of the plurality of QoS flows, a variance of the measurement values of the plurality of QoS flows, or a difference between measurement values of two QoS flows, further improves calculation accuracy.

A specific form of the association identifier is not limited in this embodiment of the present disclosure, provided that the association identifier can be configured for instructing to perform associated measurement on the QoS parameters of the n QoS flows.

For example, the associated measurement may refer to simultaneously performing QoS measurement on the plurality of QoS flows. Because the QoS flows are consistent in measurement time, during calculation of the total measurement result of the QoS parameters to be measured of the target service, an error value can be reduced and accuracy of the total measurement result of the QoS parameters to be measured of the target service can be improved. “Simultaneously” in this embodiment of the present disclosure means being performed at a same or similar time point, that is, a time error range is allowed, and triggering the QoS measurement on the plurality of QoS flows at a time point within the time error range may be considered as obtaining measurement results simultaneously.

For another example, the associated measurement may refer to triggering QoS measurement on the plurality of QoS flows at a same specified measurement time point. In this way, respective measurement results of the plurality of QoS flows may also be obtained simultaneously. Therefore, during calculation of the total measurement result of the QoS parameters to be measured of the target service, an error value can be reduced and accuracy of the total measurement result of the QoS parameters to be measured of the target service can be improved.

Although the foregoing examples are all illustrated with a plurality of QoS flows, the method provided in this embodiment of the present disclosure is also applicable to a scenario of one QoS flow. That is, for a PCC rule of one QoS flow, the PCF may also add an association identifier to a QoS detection rule thereof. The following are all examples with a plurality of QoS flows.

In some embodiments, the QoS detection rule included in the PCC rule transmitted by the PCF to the SMF may further include one or more of the following information:
rule identification information: configured for uniquely identifying a PCC rule in a PDU session, and configured between the PCF and the SMF for referencing the PCC rule (Uniquely identifies the PCC rule, within a PDU Session. It is used between PCF and SMF for referencing PCC rules);
service data flow detection information: this part defines a method for detecting a data packet belonging to a service data flow (This part defines the method for detecting packets belonging to a service data flow), and the service data flow detection information may be, for example, a five-tuple configured for identifying a service data flow;
QoS parameter to be measured: including an uplink (UL) data packet delay, a downlink (DL) data packet delay, a round-trip data packet delay, a data transmission rate, congestion information, and the like;
reporting frequency: defining a reporting frequency of a measurement result, such as triggered by an event or periodically;
reporting target: defining a network element to which the measurement result needs to be reported; and
direct reporting indication: defining that the measurement result needs to be directly reported to the related network element.

S320: Transmit the respective PCC rules of the n data flows to an SMF.

In some embodiments, the method provided in this embodiment of the present disclosure may further include: receiving QoS detection information that is returned in response to the transmitted respective PCC rules of the n data flows, the QoS detection information including associated measurement information of the QoS parameters to be measured of the n data flows.

In this embodiment of the present disclosure, after receiving the n PCC rules transmitted by the PCF, the SMF may generate, according to the n PCC rules, respective QoS detection requests of the n QoS flows. If the SMF detects that the n PCC rules carry a same association identifier, the SMF may add same associated measurement indication information in the generated n QoS detection requests. Then, the SMF may transmit the n QoS detection requests to the UPF. After receiving the n QoS detection requests, the UPF may learn, according to the same associated measurement indication information carried in the n QoS detection requests, that associated measurement needs to be performed on the n QoS flows. Then, the UPF triggers measurement on the QoS parameters to be measured of the n QoS flows at a same or similar time point, or triggers detection at a specified measurement time point, to obtain associated measurement information. According to a QoS parameter measurement reporting requirement, the UPF reports measurement results of the QoS parameters to be measured of the n QoS flows to the SMF. The SMF forwards the received measurement results of the QoS parameters to be measured of the n QoS flows to the PCF. The PCF receives the measurement results of the QoS parameters to be measured that are returned in response to the n PCC rules transmitted by the PCF.

In an exemplary embodiment, the method provided in this embodiment of the present disclosure may further include: performing, when the associated measurement information includes measurement results of the QoS parameters to be measured of the n data flows, associated calculation on the measurement results of the QoS parameters to be measured of the n data flows to obtain an associated calculation result.

In some embodiments, after obtaining the measurement results of the n QoS flows, the UPF may directly return the measurement results of the n QoS flows to the SMF, and then the SMF returns the measurement results of the n QoS flows to the PCF. After receiving the measurement results of the n QoS flows, the PCF performs associated calculation on the measurement results of the n QoS flows, such as calculating at least one of average value information, difference information, deviation information, and the like of the measurement results of the n QoS flows as a total measurement result of the QoS parameters to be measured of the target service, that is, as the associated calculation result.

In some other embodiments, after obtaining the measurement results of the n QoS flows, the UPF may perform associated calculation on the measurement results of the n QoS flows, to obtain an associated calculation result, and return the associated calculation result of the n QoS flows to the SMF. Then, the SMF returns the associated calculation result of the n QoS flows to the PCF.

In still some other embodiments, after obtaining the measurement results of the n QoS flows, the UPF may return the measurement results of the n QoS flows to the SMF. After receiving the measurement results of the n QoS flows, the SMF performs associated calculation on the measurement results of the n QoS flows, to obtain an associated calculation result, and then returns the associated calculation result of the n QoS flows to the PCF.

According to the network QoS measurement method provided in some implementations of the present disclosure, during generation of respective PCC rules of n data flows, a PCF adds a QoS detection rule to each of the PCC rules and adds an association identifier to the QoS detection rule, so that the n data flows have a same association identifier. Therefore, an SMF may be instructed, by using the association identifier, to perform associated measurement on QoS parameters to be measured of the n data flows, thereby improving accuracy of performing associated calculation on the QoS parameters to be measured of the n data flows.

FIG. 4 is a schematic flowchart of a network QoS measurement method according to an embodiment of the present disclosure. The method provided in the embodiment of FIG. 4 may be performed by an SMF, but the present disclosure is not limited thereto. As shown in FIG. 4, the method provided in this embodiment of the present disclosure may include the following operations.

S410: Receive respective PCC rules of n data flows, n being a positive integer greater than or equal to 1, each of the PCC rules including a QoS detection rule, each of the QoS detection rules including an association identifier and a QoS parameter to be measured, the n data flows having the same association identifier and same QoS parameters to be measured, and the association identifier being configured for instructing to perform associated measurement on the QoS parameters to be measured of the n data flows.

In an exemplary embodiment, the n data flows come from a single protocol data unit session of a single UE, or a plurality of protocol data unit sessions of a single UE, or one or more protocol data unit sessions of a plurality of UEs.

S420: Generate respective QoS detection requests of the n data flows according to the respective PCC rules of the n data flows, each of the QoS detection requests including associated measurement indication information and the QoS parameter to be measured, and the n data flows having the same associated measurement indication information and same QoS parameters to be measured.

In this embodiment of the present disclosure, the SMF may receive the respective PCC rules of the n data flows from a PCF. The SMF may generate respective QoS detection requests of n QoS flows according to the respective PCC rules of the n data flows. If the SMF detects that the PCC rules received by the SMF include a same association identifier, the SMF adds associated measurement indication information to the corresponding QoS detection requests, so that the n QoS flows have the same associated measurement indication information. The associated measurement indication information may be configured for instructing the UPF to perform associated measurement on QoS parameters to be measured of the n QoS flows.

In some embodiments, the associated measurement indication information includes associated measurement identification information, and the associated measurement identification information is configured for instructing the UPF to trigger detection on the QoS parameters to be measured of the n data flows at a time point within a time error range.

In some other embodiments, the associated measurement indication information includes synchronous measurement indication information, and the synchronous measurement indication information is configured for instructing the UPF to trigger detection on the QoS parameters to be measured of the n data flows at a specified measurement time point.

The method provided in this embodiment of the present disclosure may be a scenario in which associated measurement of a QoS parameter to be measured is performed on a plurality of QoS flows in a single PDU session of a single UE. In this scenario, the associated measurement on the plurality of QoS flows is performed by a same UPF. In some embodiments, the associated measurement indication information may include associated measurement identification information, and the associated measurement identification information may be configured for instructing the UPF to trigger detection on the QoS parameters to be measured of the n QoS flows at a same or similar time point. In some other embodiments, the associated measurement indication information may include synchronous measurement indication information, and the synchronous measurement indication information may be configured for instructing the UPF to trigger detection on the QoS parameters to be measured of the n QoS flows at a specified measurement time point.

The method provided in this embodiment of the present disclosure may alternatively be a scenario in which associated measurement of a QoS parameter to be measured is performed on QoS flows of a plurality of PDU sessions of a single UE or on QoS flows of one or more PDU sessions of a plurality of UEs. This scenario may correspond to a plurality of SMFs and a plurality of UPFs. In this case, the associated measurement indication information may include synchronous measurement indication information, and the synchronous measurement indication information may be configured for instructing each of the plurality of UPFs to separately trigger detection on the QoS parameters to be measured of the n QoS flows at a specified measurement time point. Therefore, when the n QoS flows correspond to different UPFs, specifying measurement time points at the different UPFs in advance may also obtain measurement results at a same or similar time point.

In an exemplary embodiment, the specified measurement time point is a time point preconfigured in the UPF.

In an exemplary embodiment, the method provided in this embodiment of the present disclosure may further include: transmitting a configuration message to the UPF, the configuration message including the specified measurement time point.

In some embodiments, a time point at which QoS measurement of a QoS flow is triggered may be preconfigured in a corresponding UPF as the specified measurement time point. In some other embodiments, the SMF may dynamically configure and update, for the UPF by using a message between the SMF and the UPF (for example, by using parameter information of a newly added specified measurement time point in an existing message or by using a newly added message), a time point at which synchronous measurement is performed on the UPF side, that is, the specified measurement time point.

In an exemplary embodiment, each of the QoS detection rules further includes a reporting frequency, and the specified measurement time point is determined according to the reporting frequency.

In some embodiments, the specified measurement time point may be a time point being a multiple of ten ms in each second such as the 10th ms, the 20th ms, or the 30th ms, and a specific value of the multiple of ten ms may be determined as required by a reporting frequency in a corresponding QoS detection request.

In some embodiments, the QoS detection request of the corresponding UPF that is generated by the SMF according to the received PCC rule may further include at least one of information such as a QoS flow identity (QFI), information about a QoS parameter to be measured (Requested QoS Monitoring), a reporting frequency, a measurement period, a packet delay threshold, and a minimum wait time.

S430: Transmit the respective QoS detection requests of the n data flows to a UPF to instruct, by using the associated measurement indication information, the UPF to perform associated measurement on the QoS parameters to be measured of the n data flows.

In an exemplary embodiment, the method provided in this embodiment of the present disclosure may further include: receiving QoS detection information that is returned in response to the transmitted respective QoS detection requests of the n data flows, the QoS detection information including associated measurement information of the QoS parameters to be measured of the n data flows; and transmitting the QoS detection information to a PCF.

In this embodiment of the present disclosure, the associated measurement information received by the SMF may be measurement results of the QoS parameters to be measured of the n data flows, or may be an associated calculation result of the QoS parameters to be measured of the n data flows.

According to the network QoS measurement method provided in some implementations of the present disclosure, when an SMF receives respective PCC rules of n data flows, if the SMF detects that the PCC rules received by the SMF include a same association identifier, during generation of respective QoS detection requests of the n data flows, the SMF may add associated measurement indication information to each of the QoS detection requests, so that the n data flows have the same associated measurement indication information and a UPF is instructed, by using the associated measurement indication information, to perform associated measurement on QoS parameters to be measured of the n data flows. In this way, accuracy of performing associated calculation on the QoS parameters to be measured of the n data flows can be improved.

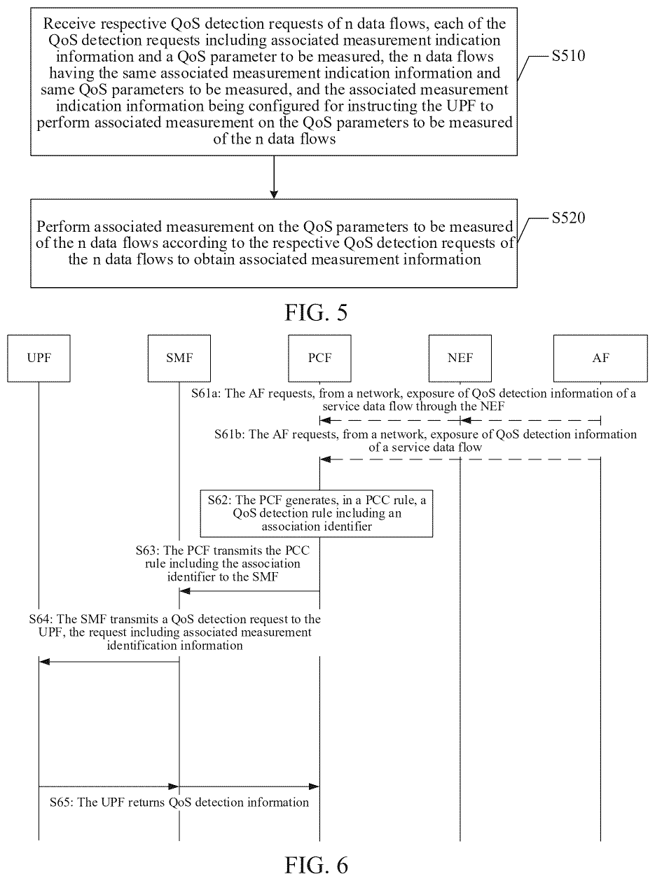

FIG. 5 is a schematic flowchart of a network QoS measurement method according to an embodiment of the present disclosure. The method provided in the embodiment of FIG. 5 may be performed by a UPF, but the present disclosure is not limited thereto. As shown in FIG. 5, the method provided in this embodiment of the present disclosure may include the following operations.

S510: Receive respective QoS detection requests of n data flows, each of the QoS detection requests including associated measurement indication information and a QoS parameter to be measured, the n data flows having the same associated measurement indication information and same QoS parameters to be measured, and the associated measurement indication information being configured for instructing the UPF to perform associated measurement on the QoS parameters to be measured of the n data flows.

S520: Perform associated measurement on the QoS parameters to be measured of the n data flows according to the respective QoS detection requests of the n data flows to obtain associated measurement information.

In an exemplary embodiment, the associated measurement indication information may include associated measurement identification information. The performing associated measurement on the QoS parameters to be measured of the n data flows according to the respective QoS detection requests of the n data flows to obtain associated measurement information may include: triggering detection on the QoS parameters to be measured of the n data flows having same associated measurement identification information at a time point within a time error range to obtain the associated measurement information.

In this embodiment of the present disclosure, the UPF may receive, from the SMF, the respective QoS detection requests of the n data flows. If all the QoS detection requests received by the UPF include same associated measurement identification information, the UPF may trigger QoS measurement on the n data flows at a same or similar time point to obtain QoS measurement results of the n data flows.

In an exemplary embodiment, the associated measurement indication information may include synchronous measurement indication information. The performing associated measurement on the QoS parameters to be measured of the n data flows according to the respective QoS detection requests of the n data flows to obtain associated measurement information may include: triggering detection on the QoS parameters to be measured of the n data flows having same synchronous measurement indication information at a specified measurement time point to obtain the associated measurement information.

In this embodiment of the present disclosure, the UPF may receive, from the SMF, the respective QoS detection requests of the n data flows. If the QoS detection requests received by the UPF include same synchronous measurement indication information, the UPF may trigger, at a specified measurement time point, QoS measurement on the QoS flows respectively corresponding to the n data flows to obtain QoS measurement results of the corresponding QoS flows.

In an exemplary embodiment, the associated measurement indication information may be further configured for instructing the UPF to perform associated reporting of the associated measurement information.

In this embodiment of the present disclosure, the associated reporting means that the reporting of associated measurement information of the n data flows has an association rather than being performed separately and independently. In some embodiments, the UPF may be further instructed, by using the associated measurement identification information, to report a measurement result and/or an associated calculation result at a same or similar time point, such as reporting the measurement result and/or the associated calculation result to the SMF. The SMF then forwards the measurement result and the associated calculation result to the PCF. In some other embodiments, the UPF may be further instructed, by using the synchronous measurement indication information, to report a measurement result and/or an associated calculation result at a specified measurement time point. In still some other embodiments, the QoS detection request may further include associated reporting indication information. The associated reporting indication information may be different from the associated measurement indication information. The associated reporting indication information may be configured for instructing the UPF to perform associated reporting of the associated measurement information. The associated reporting indication information may include associated reporting identification information, for instructing the UPF to report a measurement result and/or an associated calculation result at a same or similar time point. The associated reporting indication information may also include synchronous reporting indication information, for instructing the UPF to report a measurement result and/or an associated calculation result at a specified reporting time point. The specified reporting time point indicated by the associated reporting indication information may be the same as or different from the specified measurement time point indicated by the synchronous measurement indication information.

In an exemplary embodiment, the performing associated measurement on the QOS parameters to be measured of the n data flows according to the respective QoS detection requests of the n data flows to obtain associated measurement information may include: performing associated measurement on the QoS parameters to be measured of the n data flows according to the associated measurement indication information to obtain measurement results of the QoS parameters to be measured of the n data flows. The associated measurement information may include the measurement results of the QoS parameters to be measured of the n data flows.

In an exemplary embodiment, the performing associated measurement on the QoS parameters to be measured of the n data flows according to the respective QoS detection requests of the n data flows to obtain associated measurement information may further include: performing associated calculation on the measurement results of the QoS parameters to be measured of the n data flows to obtain an associated calculation result. The associated measurement information may include the associated calculation result.

In an exemplary embodiment, the associated calculation result may include at least one of difference information, average value information, deviation information, and the like of the measurement results of the QoS parameters to be measured of the n data flows.

The difference information is applicable to a case that n is equal to 2. In this case, the difference information refers to calculating a difference between the two measurement results. For example, it is assumed that there are two downlink QoS flows, a network delay of one of the two downlink QoS flows is 10 ms, and a network delay of the other one is 5 ms. In this case, difference information between the two downlink QoS flows is equal to 10−5=5 ms.

The average value information is an average value obtained by calculating a sum of the n measurement results and then dividing the sum by n.

The deviation information refers to collecting statistics on jitters of the n measurement results. For example, variances of the n measurement results may be calculated, but the present disclosure is not limited thereto.

In an exemplary embodiment, the method provided in this embodiment of the present disclosure may further include: generating and transmitting QoS detection information, the QoS detection information including the associated measurement information.

According to the network QoS measurement method provided in some implementations of the present disclosure, when the UPF receives the QoS detection requests of the n data flows, if the UPF detects that the n QoS detection requests include same associated measurement indication information, the UPF may perform associated measurement on the QoS parameters to be measured of the n data flows at a same or similar time point or a specified measurement time point according to the associated measurement indication information carried in the n QoS detection requests. In this way, accuracy of performing associated calculation on the QoS parameters to be measured of the n data flows can be improved.

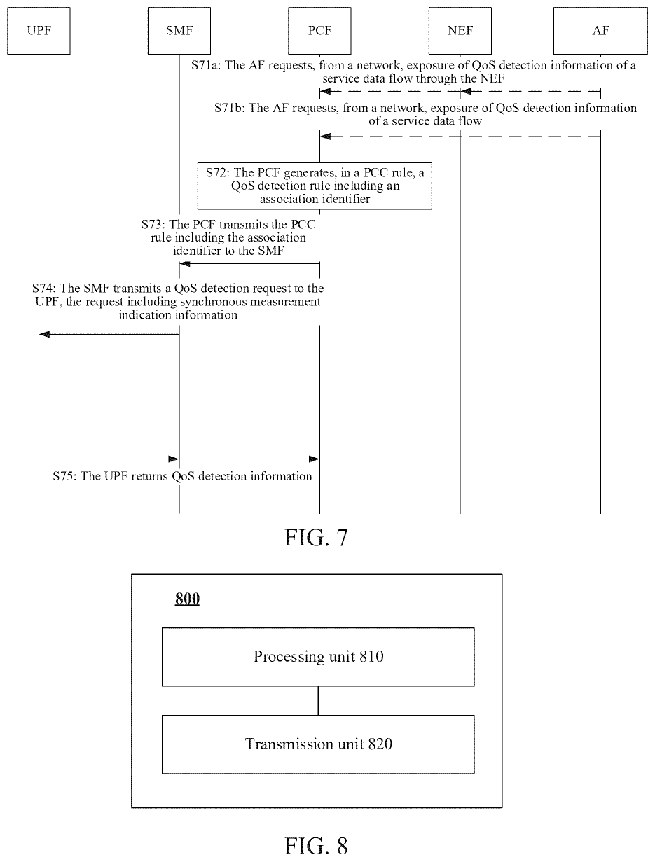

The methods provided in the embodiments of the present disclosure are separately described below by way of example with reference to FIG. 6 and FIG. 7, but the present disclosure is not limited thereto. In the embodiments of the present disclosure, the AF may be an functional unit abstracted in the service server.

As shown in FIG. 6, the method provided in the embodiments of the present disclosure may include:

transmitting, by the AF, a request to the PCF directly or indirectly (through a network exposure function (NEF)).

S61a: The AF requests, from a network (which refers to the PCF herein), exposure of QoS detection information of a service data flow through the NEF.

In some embodiments, a request transmitted by the AF to the network may include at least one of an AF identifier (AF ID), service data flow template information, and information such as parameter information (for example, a transmission delay, a transmission rate, congestion information, and a delay difference), data network name (DNN) information, and/or single network slice selection assistance information (S-NSSAI) whose exposure is requested. The service data flow template information may include one or more of a source Internet Protocol (IP) address, a source port number, a destination IP address, a destination port number, a fully qualified domain name (FQDN), an application identifier (APP ID), an IP protocol, and the like.

After receiving the request, the NEF may perform authentication and verification on the request. After the authentication and verification on the request succeed, the NEF returns a response message to the AF. The response message includes indication information of whether the request is approved. If the authentication and verification on the request fail, the indication information indicates that the request is rejected, and in some embodiments, may further include a reject cause value. If the request is approved, the NEF transmits the request to the PCF.

S61b: The AF requests, from a network (which refers to the PCF herein), exposure of QoS detection information of a service data flow.

After receiving the request, the PCF may perform authentication and verification on the request. After the authentication and verification on the request succeed, the PCF returns a response message to the AF. The response message includes indication information of whether the request is approved. If the authentication and verification on the request fail, the indication information indicates that the request is rejected, and in some embodiments, may further include a reject cause value.

S62: The PCF generates, in a PCC rule, a QoS detection rule including an association identifier.

After the PCF receives the request, if the authentication and verification on the request succeed, the PCF generates a PCC rule according to information carried in the request. The PCC rule includes a QoS detection rule. When the PCF needs to generate a QoS detection rule in a PCC rule of the service data flow, the QoS detection rule may include service data flow detection information of the service data flow. The service data flow detection information may be feature information of the service data flow that is extracted based on service data flow template information in the request, for example, may be a five-tuple of the service data flow. If the PCF determines that parameter information (that is, information about a QoS parameter to be measured) of a requested target service needs to correspond to a plurality of PCC rules, that is, associated measurement needs to be performed on a same QoS parameter to be measured for QoS detection of a service data flow, or associated calculation needs to be performed on a measurement result, respective QoS detection rules of the plurality of PCC rules include a same association identifier. That is, n service data flows correspond to n PCC rules, each of the PCC rules includes a QoS detection rule, and the QoS detection rules of these PCC rules include a same association identifier.

S63: The PCF transmits the PCC rule including the association identifier to an SMF.

The PCF transmits a plurality of generated PCC rules to the SMF. In the embodiments of the present disclosure, the PCC rules and the QoS detection rules may be combined, separated, or used as part of other rules, and may have different names depending on execution entities. This is not limited in the present disclosure.

In the embodiments of the present disclosure, the UE has established a PDU session (such as a specific DNN or an S-NSSAI) for the target service, or the UE initiates a PDU session establishment procedure (for example, for a specific DNN or an S-NSSAI) for the target service. The SMF may select a UPF.

S64: The SMF transmits a QoS detection request to the UPF, the request including associated measurement identification information.

The SMF may generate a QoS detection request according to the QoS detection rule in the PCC rules received by the SMF, and transmit the generated QoS detection request to the UPF. The QoS detection request may include the associated measurement identification information. Usually, each PCC rule is associated with one QoS flow.

When the QoS detection rule in the PCC rule received by the SMF includes the association identifier, the SMF determines that in corresponding QoS detection, associated measurement on QoS parameters to be measured needs to be performed for a plurality of QoS flows. Therefore, the SMF generates respective QoS detection requests of the plurality of QoS flows. The QoS detection requests include same associated measurement identification information. The associated measurement identification information is configured for instructing the UPF to trigger, at a same or similar time point, detection on the QoS parameter to be measured in the QoS detection requests including the associated measurement identification information. In some embodiments, the UPF may be further instructed to report a measurement result and/or an associated calculation result at a same or similar time point.

In the embodiments of the present disclosure, the SMF may generate a service data flow template according to the service data flow template information of the service data flow. The PCF may obtain the service data flow template information from the request transmitted by the AF, or may obtain the service data flow template information in other manners. This is not limited in the present disclosure.

S65: The UPF returns QoS detection information to the SMF, and the SMF returns the QoS detection information to the PCF.

The UPF receives the QoS detection request transmitted by the SMF, and according to the QoS detection request, the UPF performs detection on a corresponding QoS flow, to obtain a measurement result of a QoS parameter to be measured between the UE and the UPF.

In the embodiments of the present disclosure, the QoS detection information returned by the UPF may indicate whether the QoS detection request is accepted. After the UPF accepts the QoS detection request, the UPF performs associated measurement on a plurality of QoS flows that include associated measurement identification information, that is, initiates measurement on QoS parameters to be measured of the QoS flows at a same or similar time point, and returns QoS detection information to the SMF. The SMF returns the QoS detection information to the PCF.

When the QoS detection request received by the UPF includes the associated measurement identification information, the UPF triggers, at a same or similar time point according to a measurement requirement, measurement on the QoS parameters to be measured of the QoS flows that include the associated measurement identification information.

In some embodiments, the UPF may report measurement results and/or associated calculation results of QoS flows having same associated measurement identification information to a network function (such as a PCF, a NEF, or an AF) network element of a core network control plane such as an SMF at a same or similar time point. The network function network element of the core network control plane performs associated calculation on the measurement results of the plurality of QoS flows, such as calculating difference information, average value information, deviation information, and the like as associated calculation results. In some embodiments, after obtaining measurement results of QoS flows having same associated measurement identification information, the UPF may perform associated calculation, and report an associated calculation result to a network function network element of a core network control plane such as the SMF.

According to the method provided in the embodiments of the present disclosure, a joint QoS parameter measurement problem of a plurality of QoS flows can be resolved. A specific association identifier is added to a QoS detection rule, so that the SMF may add specific associated measurement identification information to a generated QoS detection request. When detecting the associated measurement identification information, the UPF performs associated measurement processing on the plurality of QoS flows having the associated measurement identification information, thereby ensuring that measurement results of QoS parameters of a plurality of service data flows are obtained at a same or similar time point. In this way, accuracy of performing associated calculation on QoS parameters to be measured of the plurality of QoS flows can be improved.

As shown in FIG. 7, the method provided in the embodiments of the present disclosure may include the following operations.

S71a: An AF requests, from a network (which refers to a PCF herein), exposure of QoS detection information of a service data flow of a target service through a NEF.

S71b: The AF requests, from a network (which refers to the PCF herein), exposure of QoS detection information of a service data flow of a target service.

S72: The PCF generates, in a PCC rule, a QoS detection rule including an association identifier.

S73: The PCF transmits the PCC rule including the association identifier to an SMF.

For S71a, S71b, S72, and S73, refer to S61a, S61b, S62, and S63 described above.

S74: The SMF transmits the QoS detection request to a UPF, the request including synchronous measurement indication information.

The SMF may generate a QoS detection request according to a QoS detection rule in the PCC rule received by the SMF, and transmit the generated QoS detection request to the UPF. The QoS detection request may include synchronous measurement indication information.

When the QoS detection rule in the PCC rule received by the SMF includes the association identifier, the SMF determines that in corresponding QoS detection, associated measurement on QoS parameters to be measured needs to be performed for a plurality of QoS flows. Therefore, the SMF generates respective QoS detection requests of the plurality of QoS flows. The generated QoS detection requests include synchronous measurement indication information, that is, information indicating whether synchronous measurement needs to be performed for the QoS flows. The synchronous measurement indication information is configured for instructing the UPF to trigger, at a specified measurement time point, detection on QoS parameters to be measured in the QoS detection requests including the synchronous measurement indication information. In some embodiments, the UPF may be further instructed to report a measurement result and/or an associated calculation result at the specified measurement time point.

S75: The UPF returns the QoS detection information to the SMF, and the SMF returns the QoS detection information to the PCF.

The UPF receives the QoS detection request transmitted by the SMF, and when the QoS detection request received by the UPF includes the synchronous measurement indication information, the UPF initiates measurement on a QoS parameter to be measured of the QoS flow at the specified measurement time point. In the embodiments of the present disclosure, the UPF does not need to consider the number of QoS flows on which associated measurement needs to be performed, because regardless of a specific QoS flow on which associated measurement is performed, QoS measurement is triggered at the specified measurement time points. In this way, synchronization of measurement results is ensured.

According to the method provided in the embodiments of the present disclosure, a joint QoS parameter measurement problem of a plurality of QoS flows can be resolved. A specific association identifier is added to a QoS detection rule, so that the SMF may add specific synchronous measurement indication information to a generated QoS detection request. When detecting the synchronous measurement indication information, the UPF performs associated measurement processing on a plurality of QoS flows having same synchronous measurement indication information, thereby ensuring that measurement results of QoS parameters of a plurality of service data flows are obtained at a same specified measurement time point. In this way, accuracy of performing associated calculation on QoS parameters to be measured of the plurality of QoS flows can be improved.

The methods in the embodiments of FIG. 6 and FIG. 7 may be a scenario in which associated measurement of a QoS parameter to be measured needs to be performed on a plurality of QoS flows in a single PDU session of a single UE (in this scenario, detection is performed by a same UPF).

When associated measurement of a QoS parameter to be measured needs to be performed on QoS flows in a plurality of PDU sessions of a single UE or QoS flows of a plurality of UEs, the solution needs to be enhanced. When the PCF considers that the measurement results of the QoS parameters to be measured of the service data flows need to be for a plurality of PDU sessions or for a plurality of UEs, the PCF adds a new association identifier to respective QoS detection rules of a plurality of generated PCC rules, and transmits the plurality of PCC rules to a plurality of related SMFs. The SMF transmits the QoS detection request to the UPF. A plurality of PDU sessions for a plurality of UEs or a single UE may correspond to a plurality of SMFs and UPFs. Specific implementation is also based on the method in the embodiment of FIG. 7. In this case, the plurality of UPFs need to set a same specified measurement time point.

According to the method provided in the embodiments of the present disclosure, a synchronous measurement solution for a QoS parameter to be measured is provided, to ensure that when associated measurement is performed on QoS parameters to be measured of a plurality of service data flows, synchronous measurement results of the plurality of associated service data flows are obtained.

Although the embodiments of FIG. 6 and FIG. 7 both use examples in which an AF and a PCF directly exchange information or indirectly exchange information through a NEF, the present disclosure is not limited thereto. In other embodiments, the NEF may alternatively store information carried in a request transmitted by the AF into a unified data repository (UDR), and the PCF may receive the information from the UDR.

FIG. 8 is a schematic block diagram of a PCF according to an embodiment of the present disclosure. A PCF 800 provided in the embodiment of FIG. 8 may include a processing unit 810 and a transmission unit 820.

The processing unit 810 may be configured to generate respective PCC rules of n data flows, n being a positive integer, each of the PCC rules including a QoS detection rule, each of the QoS detection rules including an association identifier and a QoS parameter to be measured, the n data flows having the same association identifier and same QoS parameters to be measured, and the association identifier being configured for instructing to perform associated measurement on the QoS parameters to be measured of the n data flows.

The transmission unit 820 may be configured to transmit the respective PCC rules of the n data flows to an SMF.

For other content of the PCF provided in the embodiment of FIG. 8, refer to other embodiments described above.

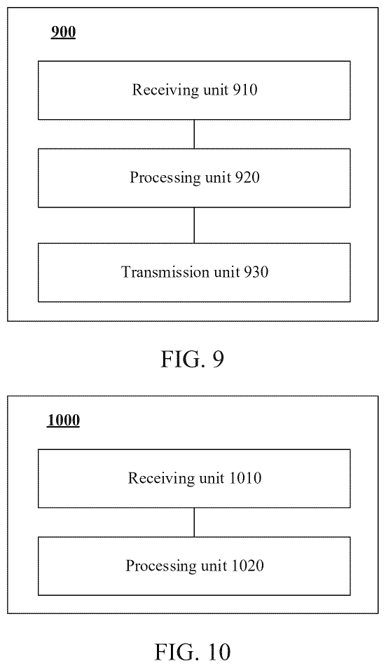

FIG. 9 is a schematic block diagram of an SMF according to another embodiment of the present disclosure. An SMF 900 provided in the embodiment of FIG. 9 may include a receiving unit 910, a processing unit 920, and a transmission unit 930.

The receiving unit 910 may be configured to receive respective PCC rules of n data flows, n being a positive integer, each of the PCC rules including a QoS detection rule, each of the QoS detection rules including an association identifier and a QoS parameter to be measured, the n data flows having the same association identifier and same QoS parameters to be measured, and the association identifier being configured for instructing to perform associated measurement on the QoS parameters to be measured of the n data flows.

The processing unit 920 may be configured to generate respective QoS detection requests of the n data flows according to the respective PCC rules of the n data flows, each of the QoS detection requests including associated measurement indication information and the QoS parameter to be measured, and the n data flows having same associated measurement indication information.

The transmission unit 930 may be configured to transmit the respective QoS detection requests of the n data flows to a UPF to instruct, by using the associated measurement indication information, the UPF to perform associated measurement on the QoS parameters to be measured of the n data flows.

For other content of the SMF provided in the embodiment of FIG. 9, refer to other embodiments described above.

FIG. 10 is a schematic block diagram of a UPF according to another embodiment of the present disclosure. As shown in FIG. 10, a UPF 1000 provided in this embodiment of the present disclosure may include a receiving unit 1010 and a processing unit 1020.

The receiving unit 1010 may be configured to receive respective QoS detection requests of n data flows, each of the QoS detection requests including associated measurement indication information and a QoS parameter to be measured, the n data flows having the same associated measurement indication information and same QoS parameters to be measured, and the associated measurement indication information being configured for instructing the UPF to perform associated measurement on the QoS parameters to be measured of the n data flows.

The processing unit 1020 may be configured to perform associated measurement on the QoS parameters to be measured of the n data flows according to the respective QoS detection requests of the n data flows to obtain associated measurement information.

For other content of the UPF provided in the embodiment of FIG. 10, refer to other embodiments described above.

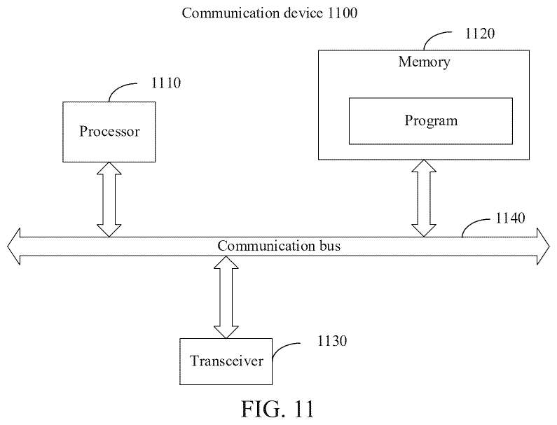

FIG. 11 is a schematic structural diagram of a communication device 1100 according to an embodiment of the present disclosure. The communication device may be a terminal such as a UE, or a network device such as a base station, or a PCF and/or a NEF and/or an AF and/or an SMF and/or a UPF. The communication device 1100 shown in FIG. 11 includes a processor 1110. The processor 1110 may invoke and run a computer program from a memory to implement the method in the embodiments of the present disclosure.

In some embodiments, as shown in FIG. 11, the communication device 1100 may further include a memory 1120. The processor 1110 may invoke and run a computer program from the memory 1120 to implement the method in the embodiments of the present disclosure.

The memory 1120 may be a separate device independent of the processor 1110, or may be integrated into the processor 1110.

In some embodiments, as shown in FIG. 11, the communication device 1100 may further include a transceiver 1130. The processor 1110 may control the transceiver 1130 to communicate with another device. Specifically, the transceiver may transmit information or data to the another device, or may receive information or data transmitted by the another device.

The transceiver 1130 may include a transmitter (which may be used as the transmission unit in the foregoing embodiments) and a receiver (which may be used as the receiving unit in the foregoing embodiments). The transceiver 1130 may further include an antenna, and there may be one or more antennas.

In some embodiments, the communication device 1100 may be specifically various network elements in the embodiments of the present disclosure, and the communication device 1100 may implement corresponding procedures implemented by the network elements in various methods of the embodiments of the present disclosure. For brevity, details are not described herein again.

In some embodiments, the communication device 1100 may be specifically a mobile terminal/a terminal in the embodiments of the present disclosure, and the communication device 1100 may implement corresponding procedures implemented by the mobile terminal/the terminal in various methods of the embodiments of the present disclosure. For brevity, details are not described herein again.

In some embodiments, the processor 1110, the memory 1120, and the transceiver 1130 may implement bidirectional communication with each other through a communication bus 1140.

The processor in this embodiment of the present disclosure may be an integrated circuit chip having a signal processing capability. In an implementation process, the operations in the foregoing method embodiments may be implemented by using a hardware integrated logical circuit in the processor, or by using instructions in a form of software.

The processor may be a general-purpose processor, a digital signal processor (DSP), an application-specific integrated circuit (ASIC), a field programmable gate array (FPGA), or another programmable logic device, a discrete gate or transistor logic device, or a discrete hardware component; and may implement or perform the methods, the operations, and logic block diagrams that are disclosed in the embodiments of the present disclosure. The general-purpose processor may be a microprocessor, or the processor may be any conventional processor or the like. The operations of the methods disclosed with reference to the embodiments of the present disclosure may be directly performed and completed by using a hardware decoding processor, or may be performed and completed by using a combination of hardware and software modules in a decoding processor. The software module may be located in a storage medium that is mature in the art, such as a random access memory (RAM), a flash memory, a read-only memory (ROM), a programmable ROM (PROM), an electrically erasable programmable memory, or a register. The storage medium is located in the memory. The processor reads information in the memory and completes the operations of the foregoing methods in combination with hardware thereof.

The memory in this embodiment of the present disclosure may be a volatile memory or a non-volatile memory, or may include both a volatile memory and a non-volatile memory. The non-volatile memory may be a ROM, a PROM, an erasable PROM (EPROM), an electrically EPROM (EEPROM), or a flash memory. The volatile memory may be a RAM, serving as an external cache. Through illustrative but not restrictive description, RAMs in many forms are usable, such as a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a direct rambus RAM (DR RAM). The memories of the system and method described in this specification are intended to include, but are not limited to, these and any other suitable types of memories. The foregoing memories are exemplary but not restrictive.

An embodiment of the present disclosure further provides a computer-readable storage medium, configured to store a computer program.

In some embodiments, the computer-readable storage medium may be applied to the network elements in the embodiments of the present disclosure, and the computer program causes a computer to perform corresponding procedures implemented by the network elements in the methods of the embodiments of the present disclosure. For brevity, details are not described herein again.

In some embodiments, the computer-readable storage medium may be applied to a mobile terminal/a terminal in the embodiments of the present disclosure, and the computer program causes a computer to perform corresponding procedures implemented by the mobile terminal/the terminal in various methods of the embodiments of the present disclosure. For brevity, details are not described herein again.

An embodiment of the present disclosure further provides a computer program product, including computer program instructions.

In some embodiments, the computer program product may be applied to the network elements in the embodiments of the present disclosure, and the computer program instructions cause a computer to perform corresponding procedures implemented by the network elements in various methods of the embodiments of the present disclosure. For brevity, details are not described herein again.

In some embodiments, the computer program product may be applied to a mobile terminal/a terminal in the embodiments of the present disclosure, and the computer program instructions cause a computer to perform corresponding procedures implemented by the mobile terminal/the terminal in various methods of the embodiments of the present disclosure. For brevity, details are not described herein again.

An embodiment of the present disclosure further provides a computer program.

In some embodiments, the computer program may be applied to the network elements in the embodiments of the present disclosure, and when the computer program is run on a computer, the computer is caused to perform corresponding procedures implemented by the network elements in various methods of the embodiments of the present disclosure. For brevity, details are not described herein again.

In some embodiments, the computer program may be applied to the mobile terminal/the terminal in the embodiments of the present disclosure, and when the computer program is run on a computer, the computer is caused to perform corresponding procedures implemented by the mobile terminal/the terminal in various methods of the embodiments of the present disclosure. For brevity, details are not described herein again.

A person of ordinary skill in the art may be aware that the exemplary units and algorithm operations described with reference to the embodiments disclosed in this specification may be implemented by electronic hardware, or a combination of computer software and electronic hardware. Whether the functions are performed by hardware or software depends on particular applications and design constraint conditions of the technical solutions. A person skilled in the art may use different methods to implement the described functions for each particular application, but it is not to be considered that the implementation goes beyond the scope of the present disclosure.

A person skilled in the art may clearly understand that for convenience and conciseness of description, for a specific working process of the foregoing system, apparatus, and unit, reference may be made to a corresponding process in the foregoing method embodiments, and details are not described herein again.

In the several embodiments provided in the present disclosure, the disclosed system, apparatus, and method may be implemented in other manners. For example, the described apparatus embodiments are merely schematic. For example, the unit division is merely logical function division and may be other division in actual implementation. For example, a plurality of units or components may be combined or integrated into another system, or some features may be ignored or not performed.

The units described as separate parts may or may not be physically separate, and components displayed as units may or may not be physical units, that is, may be located in one position, or may be distributed on a plurality of network units. Some or all of the units may be selected according to actual needs to achieve the objectives of the solutions of the embodiments.

In addition, functional units in the embodiments of the present disclosure may be integrated into one processing unit, or each of the units may exist alone physically, or two or more units may be integrated into one unit.

If implemented in the form of a software functional unit and sold or used as an independent product, the functions may be stored in a computer-readable storage medium. Based on such an understanding, the technical solutions of the present disclosure essentially, or the part contributing to the related art, or some of the technical solutions may be implemented in a form of a software product. The computer software product is stored in a storage medium, and includes several instructions for instructing a computer device (which may be a personal computer, a server, a network device, or the like) to perform all or some of the operations of the methods described in the embodiments of the present disclosure. The foregoing storage medium includes: any medium that may store program code, such as a USB flash drive, a removable hard disk, a ROM, a RAM, a magnetic disk, or an optical disc.

The foregoing descriptions are merely specific implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claimed is:

1. A network quality of service (QOS) measurement method performed by a computer device acting as a policy control function (PCF) of a wireless network comprising:
generating policy and charging control (PCC) rules for n respective data flows, n being a positive integer, each of the PCC rules comprising a QoS detection rule including an association identifier and a QoS parameter to be measured, the n data flows having the same association identifier and same QoS parameters to be measured, and the association identifier being configured for performing associated measurement on the QoS parameters to be measured of the n data flows; and
transmitting the PCC rules of the n respective data flows to a session management function (SMF).

2. The method according to claim 1, wherein the performing associated measurement performed on the QoS parameters to be measured of the n data flows comprises:
triggering detection on the QoS parameters to be measured of the n data flows at a time point within a time error range.

3. The method according to claim 1, wherein the performing associated measurement on the QoS parameters to be measured of the n data flows comprises:
triggering detection on the QoS parameters to be measured of the n data flows at a specified measurement time point.

4. The method according to claim 1, wherein the n data flows come from a single protocol data unit session of a single user equipment (UE), or a plurality of protocol data unit sessions of a single UE, or one or more protocol data unit sessions of a plurality of UEs.

5. The method according to claim 1, further comprising:
receiving QoS detection information that is returned in response to the transmitted respective PCC rules of the n data flows, the QoS detection information comprising associated measurement information of the QoS parameters to be measured of the n data flows.

6. The method according to claim 5, further comprising:
performing, when the associated measurement information comprises measurement results of the QoS parameters to be measured of the n data flows, associated calculation on the measurement results of the QoS parameters to be measured of the n data flows to obtain an associated calculation result.

7. The method according to claim 6, wherein the associated calculation result comprises at least one of difference information, average value information, and deviation information of the measurement results of the QoS parameters to be measured of the n data flows.

8. A network quality of service (QOS) measurement method, performed by a computer device acting as a session management function (SMF) of a wireless network, the method comprising:
receiving, from a policy control function (PCF) of the wireless network, policy and charging control (PCC) rules of n respective data flows, n being a positive integer, each of the PCC rules comprising a QoS detection rule, each of the QoS detection rules comprising an association identifier and a QoS parameter to be measured, the n data flows having the same association identifier and same QoS parameters to be measured, and the association identifier being configured for performing associated measurement on the QoS parameters to be measured of the n data flows;
generating respective QoS detection requests of the n data flows according to the respective PCC rules of the n data flows, each of the QoS detection requests comprising associated measurement indication information and the QoS parameter to be measured, and the n data flows having same associated measurement indication information; and
transmitting the respective QoS detection requests of the n data flows to a user plane function (UPF) to instruct, by using the associated measurement indication information, the UPF to perform associated measurement on the QoS parameters to be measured of the n data flows.

9. The method according to claim 8, wherein the associated measurement indication information comprises associated measurement identification information, and the associated measurement identification information is configured for instructing the UPF to trigger detection on the QoS parameters to be measured of the n data flows at a time point within a time error range.

10. The method according to claim 9, wherein the associated measurement indication information comprises synchronous measurement indication information, and the synchronous measurement indication information is configured for instructing to trigger detection on the QoS parameters to be measured of the n data flows at a specified measurement time point.

11. The method according to claim 10, wherein each of the QoS detection rules further comprises a reporting frequency, and the specified measurement time point is determined according to the reporting frequency.

12. The method according to claim 8, wherein the n data flows come from a single protocol data unit session of a single user equipment (UE), or a plurality of protocol data unit sessions of a single UE, or one or more protocol data unit sessions of a plurality of UEs.

13. The method according to claim 8, further comprising:
receiving QoS detection information that is returned in response to the transmitted respective QoS detection requests of the n data flows, the QoS detection information comprising associated measurement information of the QoS parameters to be measured of the n data flows; and
transmitting the QoS detection information to a policy control function (PCF).

14. A network quality of service (QOS) measurement method performed by a computer device acting as a user plane function (UPF) of a wireless network, the method comprising:
receiving, from a session management function (SMF) of the wireless network, xQoS detection requests of n respective data flows, each of the QoS detection requests comprising associated measurement indication information and a QoS parameter to be measured, the n data flows having the same associated measurement indication information and same QoS parameters to be measured, and the associated measurement indication information being configured for instructing the UPF to perform associated measurement on the QoS parameters to be measured of the n data flows; and
performing associated measurement on the QoS parameters to be measured of the n data flows according to the respective QoS detection requests of the n data flows to obtain associated measurement information.

15. The method according to claim 14, wherein the associated measurement indication information comprises associated measurement identification information; and
the performing associated measurement on the QoS parameters to be measured of the n data flows according to the respective QoS detection requests of the n data flows to obtain associated measurement information comprises:
triggering detection on the QoS parameters to be measured of the n data flows having same associated measurement identification information at a time point within a time error range to obtain the associated measurement information.

16. The method according to claim 14, wherein the associated measurement indication information comprises synchronous measurement indication information; and
the performing associated measurement on the QoS parameters to be measured of the n data flows according to the respective QoS detection requests of the n data flows to obtain associated measurement information comprises:
triggering detection on the QoS parameters to be measured of the n data flows having same synchronous measurement indication information at a specified measurement time point to obtain the associated measurement information.

17. The method according to claim 14, wherein the associated measurement indication information is further configured for instructing the UPF to perform associated reporting of the associated measurement information.

18. The method according to claim 14, wherein the performing associated measurement on the QoS parameters to be measured of the n data flows according to the respective QoS detection requests of the n data flows to obtain associated measurement information comprises:
performing associated measurement on the QoS parameters to be measured of the n data flows having same associated measurement indication information to obtain measurement results of the QoS parameters to be measured of the n data flows;
the associated measurement information comprising the measurement results of the QoS parameters to be measured of the n data flows.

19. The method according to claim 18, wherein the performing associated measurement on the QoS parameters to be measured of the n data flows according to the respective QoS detection requests of the n data flows to obtain associated measurement information further comprises:
performing associated calculation on the measurement results of the QoS parameters to be measured of the n data flows to obtain an associated calculation result;
the associated measurement information comprising the associated calculation result.
